(19) United States
(12) Patent Application Publication
(10) Pub. No.: US 2013/0261831 A1
(43) Pub. Date: Oct. 3, 2013

(54) ELECTRICITY STORAGE APPARATUS FOR CONTROLLING POWER CONSUMPTION AND METHOD THEREFOR

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Se-Hee HAN, Seoul (KR); Joo-Yeol LEE, Seongnam-si (KR); Yong-Tae YOON, Seoul (KR); Young-Gyu JIN, Seoul (KR); Hyeong-Ig KIM, Seoul (KR); Si-Young LEE, Seoul (KR)

(73) Assignees: Seoul National University R&DB Foundation, Seoul (KR); Samsung Electronics Co., Ltd., Suwon-si (KR)

(21) Appl. No.: 13/853,565

(22) Filed: Mar. 29, 2013

(30) Foreign Application Priority Data
Mar. 30, 2012 (KR) 10-2012-0033556

(51) Int. Cl. G05F 1/66

(52) U.S. Cl. CPC G05F 1/66
USPC 700/295

(57) ABSTRACT

A method for controlling power consumption by an electricity storage apparatus is provided. The method includes receiving, from a utilizing side, an inquiry request signal for inquiring whether power supply from the electricity storage apparatus is possible, inquiring an amount of charged power from the electricity storage apparatus compared to a capacity of the electricity storage apparatus, comparing a required amount of power, which is included in the inquiry request signal, with the amount of charged power, and based on the comparison result, determining an amount of power to supply to the utilizing side and whether to switch to an operation mode of supplying the amount of power to the utilizing side, and upon determining to switch to the operation mode, checking an amount of available supply power in accordance with the operation mode, and transmitting information about the checked amount of available supply power to the utilizing side.

### PRIORITY

This application claims the benefit under 35 U.S.C. §119(a) of a Korean patent application filed on Mar. 30, 2012 in the Korean Intellectual Property Office and assigned Serial No. 10-2012-0033556, the entire disclosure of which is hereby incorporated by reference.

### JOINT RESEARCH AGREEMENT

The presently claimed invention was made by or on behalf of the below listed parties to a joint research agreement. The joint research agreement was in effect on or before the date the claimed invention was made and the claimed invention was made as a result of activities undertaken within the scope of the joint research agreement. The parties to the joint research agreement are 1) SAMSUNG ELECTRONICS CO., LTD., and the 2) SEOUL NATIONAL UNIVERSITY R& DB FOUNDATION.

### BACKGROUND OF THE INVENTION

1. Field of the Invention

The present invention relates to an electricity storage apparatus for controlling power consumption or power usage and a method therefore.

2. Description of the Related Art

General power systems are operated such that power supply may be adjusted to correspond to power demand. For this purpose, a variety of power supply control techniques, such as a power demand forecasting technique, an economic load dispatch technique and an automatic load dispatching control, have been devised and used.

Power supply systems, also known as generators, are generally built in a large scale in consideration of the economy of scale, and the reliability and cost savings are considered as their major operational criteria. However, in recent years, the demand for power has surged and a type of power load has changed a lot from the linear loads, which are proportional to the frequency, to nonlinear loads such as digital devices. In addition, it is difficult to build an existing large-scale power generation system due to the site selecting and massive investment risks. Owing to these situations, the interest in the role of the demand side has increased, in matching the demand and supply of power and operating the power system reliably.

The general demand-side power supply resources include, for example, renewable energy resources, and demand response resources which can be acquired through a power storage apparatus, an electricity storage apparatus and an electric car. The demand response resources may be acquired through apparatuses that can adjust power usage, such as smart appliances. The renewable energy resources refer to small solar or wind power generation apparatuses which are installed at home or local areas. The power storage apparatus refers to an apparatus that can store power in advance and supply the stored power if necessary, like the battery. The electric car is similar to the power storage apparatus in terms of the principle of operation since it basically uses a battery, but the electric car is distinguishable from the power storage apparatus installed in a fixed position, since it has additional mobility. Apparatuses that can provide these demand-side power supply resources may match the demand and supply of power in the power system in the way of reducing the power usage if the power system lacks available supply power, and increasing the power usage if the power is oversupplied from the power system.

The electricity storage apparatus may supply power by supplying the power stored in advance or reducing the amount of the power being charged, if the power system lacks power, and may increase the power usage in the time interval where the power is oversupplied, by increasing the amount of the power being charged if the power is oversupplied from the power system. For example, while charging itself with the power of 10 kWh, the electricity storage apparatus may stop the charging if the power system lacks sufficient power. On the other hand, while charging itself with the power of 10 kWh, the electricity storage apparatus may more rapidly charge itself with the power of 20 kWh if the power is oversupplied from the power system.

However, due to its limited physical capacity, the electricity storage apparatus has limits on the power it can supply at a certain time, or the range it can adjust the power being consumed, during charging. For example, if the charge state of the electricity storage apparatus corresponds to 100%, the electricity storage apparatus may not charge itself even though it desires additional charge. On the other hand, if the charge state of the electricity storage apparatus corresponds to 0%, the electricity storage apparatus has no power it can supply. In addition, if there are constraints that the charging needs to be completed at a certain time, the available supply power also needs to be matched to the constraints. Therefore, in order for the electricity storage apparatus to operate for the purpose of matching the demand and supply in the power system, detailed technical measures are required to determine in which way the electricity storage apparatus should receive a signal indicating the need for power supply, to determine in which way it can measure the available supply power, to determine in which format it can represent information about the available supply power, and to provide an interface for allowing users to set an operation of the electricity storage apparatus in a specific way.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide an electricity storage apparatus for generating a power demand adjustment signal and controlling the amount of power supply depending on the power demand adjustment signal, and a method therefore.

In accordance with an aspect of the present invention, a method for controlling power consumption by an electricity storage apparatus is provided. The method includes receiving, from a utilizing side, an inquiry request signal for inquiring whether power supply from the electricity storage apparatus is possible, inquiring an amount of charged power in the electricity storage apparatus compared to a capacity of the electricity storage apparatus, comparing a required amount of power, which is included in the inquiry request signal, with the amount of charged power in the electricity storage apparatus, and based on the comparison result, determining an amount of power to supply to the utilizing side and whether to switch to an operation mode of supplying the amount of power to the utilizing side, and upon determining to switch to the operation mode, checking an amount of available supply power in accordance with the operation mode, and transmitting information about the checked amount of available supply power to the utilizing side.

In accordance with another aspect of the present invention, an electricity storage apparatus for controlling power consumption is provided. The electricity storage apparatus includes a transceiver for receiving, from a utilizing side, an inquiry request signal for inquiring whether power supply from the electricity storage apparatus is possible, and a controller for inquiring an amount of charged power in the electricity storage apparatus compared to a capacity of the electricity storage apparatus, comparing a required amount of power, which is included in the inquiry request signal, with the amount of charged power in the electricity storage apparatus, determining, based on the comparison result, an amount of power to supply to the utilizing side and whether to switch to an operation mode of supplying the amount of power to the utilizing side, and upon determining to switch to the operation mode, checking an amount of available supply power in accordance with the operation mode, and controlling the transceiver to transmit information about the checked amount of available supply power to the utilizing side.

In accordance with another aspect of the present invention, a method for controlling power consumption is provided. The method includes detecting reception of an inquiry request signal inquiring whether an electricity storage apparatus can supply power to a utilization side, measuring an amount of power charged in the electricity storage apparatus compared to a power storage capacity of the electricity storage apparatus, inquiring a set charging rate for the power that can be supplied to the utilization side, determining whether the power can be supplied to the utilization side and whether to switch to an operation mode of supplying the power to the utilization side, calculating an available amount of power the electricity storage apparatus can supply to the utilizing side according to the set charging rate and the available amount of power, and transmitting information to the utilization size related to the available amount of power that can be supplied to the utilization side.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and/or other aspects, features, and advantages of certain exemplary embodiments of the present invention will be more apparent from the following description taken in conjunction with the accompanying drawings, in which:

FIG. 1 is a flowchart illustrating an operation of an electricity storage apparatus according to an exemplary embodiment of the present invention; and

FIG. 2 illustrates a structure of an electricity storage apparatus according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In a power collection method according to an exemplary embodiment of the present invention, signals may be transmitted and received via a variety of wire/wireless communication networks, such as wire/wireless public networks, private networks, and short-range wireless communication networks (for example, Zigbee).

The demand-side supply resources collected in the power collection method according to an exemplary embodiment of the present invention control the demand-side power supply resources to reduce the power usage or to have a positive (+) value of supplying the stored power, if they lack power, or allow the demand-side power supply resources to have a negative (−) value by increasing the power usage if the power is oversupplied from the power system. In other words, collecting power in the demand-side power supply resources may include both the demand side's receiving power, and supplying more power to the demand side.

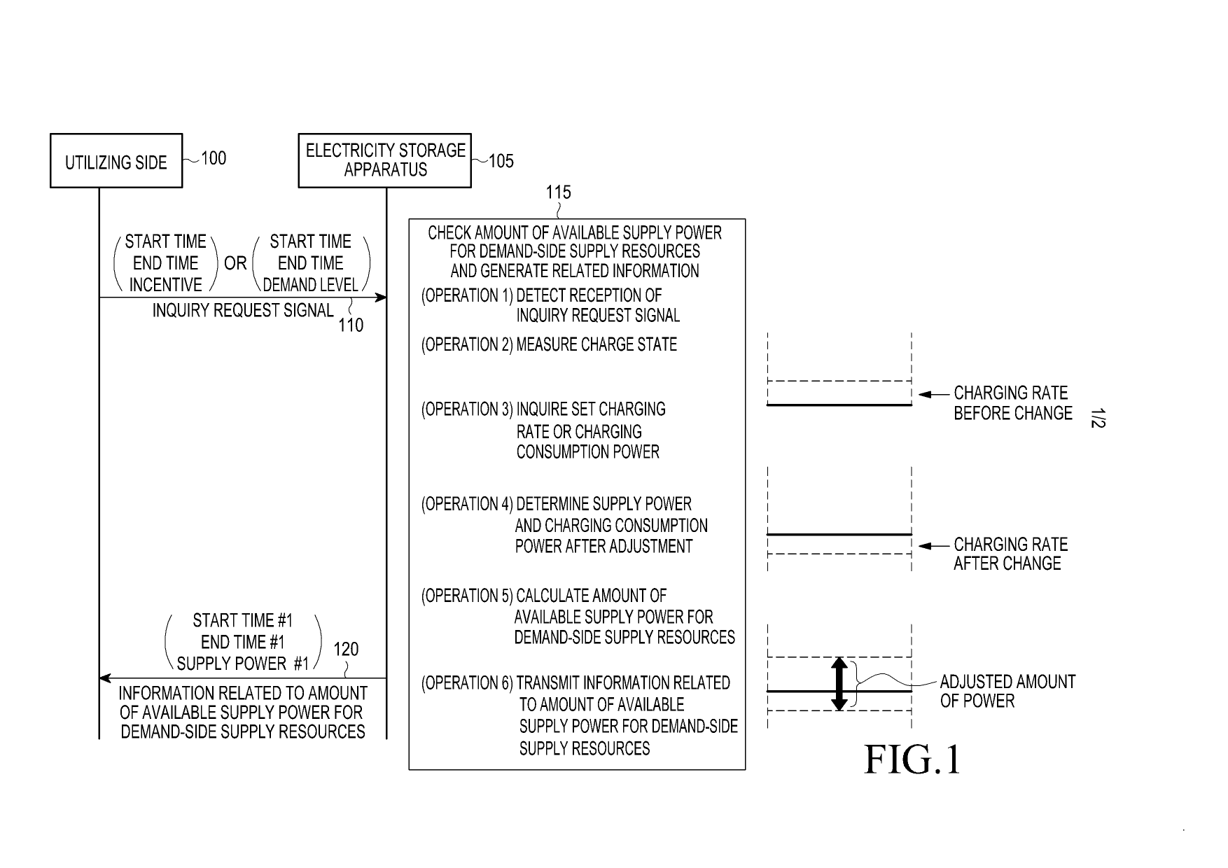

FIG. 1 is a flowchart illustrating an operation of an electricity storage apparatus according to an exemplary embodiment of the present invention.

Referring to FIG. 1, in step 110, a utilizing side 100 for the demand-side supply resources sends an inquiry request signal for inquiring whether power supply to the demand-side supply resources is possible, to an electricity storage apparatus 105.

The inquiry request signal includes utilization-related information for the demand-side supply resources that will be utilized by the utilizing side 100. The utilization-related information includes, for example, parameters indicating ‘start time’ and ‘end time’ about the time the demand-side supply resources are required, and indicating ‘incentive’ or ‘demand level’. The term ‘incentive’ as used herein may refer to the cost that the utilizing side 100 pays per unit power that is supplied by the electricity storage unit 105. The larger the required amount of power, the larger the incentive. The term ‘demand level’ as used herein may refer to a value indicating the risk in matching the demand and supply of power for the amount of power required by the utilizing side 100, meaning that the larger the demand level, the larger the difference between the demand and supply of power. Therefore, the larger the required amount of power, the larger the demand level. The ‘incentive’ is determined in advance as a contractual relationship between the utilizing side 100 and the electricity storage apparatus 105. The incentive may be applied when the utilizing side 100 needs to pay a predetermined cost to the electricity storage apparatus 105. In addition, the ‘demand level’ is a value determined by the trust relationship with the utilizing side 100, and may be utilized when there is a need to provide the demand-side supply resources even without the payment of cost from the utilizing side 100.

As a specific example, it will be assumed that the utilizing side 100 requires supply power of 10 MW from 1 PM to 2 PM on Dec. 20, 2012. Then, the inquiry request signal includes ‘start time=2012/12/20/13:00:00’, and ‘end time=2012/12/20/14:00:00’. In addition, the supply power of 10 MW is converted into ‘incentive=100 won/kWh’ or ‘demand level=3’, and displayed as internal information.

Upon receiving the inquiry request signal, the electricity storage apparatus 105 checks the amount of available supply power for the demand-side supply resources and generates related information in accordance with operation 1 to operation 6, in step 115.

In operation 1, the electricity storage apparatus 105 detects the reception of the inquiry request signal from the utilizing side 100. The electricity storage apparatus 105 acquires the utilization-related information from the above-described inquiry request signal.

In operation 2, the electricity storage apparatus 105 measures its charge state. In other words, the electricity storage apparatus 105 measures a level of the currently charged power, compared to its own capacity. For example, if an electricity storage apparatus with a capacity of 100 kWh is charged up to 50 kWh, its charge state corresponds to 50%.

In operation 3, the electricity storage apparatus 105 inquires the set charging rate or charging consumption power. The term ‘set charging rate’ or ‘charging consumption power’ as used herein may refer to the charging rate set by the user. For example, if the user sets a slow charge mode, the charging consumption power may be 1 kWh, whereas if the user sets a rapid charge mode, the charging consumption power may be 10 kWh. In this way, the charging rate, i.e., charging consumption power, may vary depending on the user's settings.

In operation 4, the electricity storage apparatus 105 determines the supply power and the charging rate (or charging consumption power) after adjustment. Operation 4 corresponds to a step of determining an operation mode of the electricity storage apparatus 105 taking the current operation mode into account. As a specific example, it will be assumed that the electricity storage apparatus 105 is in a charging mode as its operation mode while the power system lacks power. In this case, the electricity storage apparatus 105 may switch to, for example, an operation mode of reducing the charging rate (or charging consumption power), an operation mode of completely stopping the charging operation, or an operation mode of stopping the charging and supplying the stored power. As another example, it will be assumed that the electricity storage apparatus 105 is in a non-charging mode as its operation mode while the power system lacks power. In this case, the electricity storage apparatus 105 may switch to an operation mode of supplying the stored power.

In contrast, it will be assumed that the electricity storage apparatus 105 is in a charging mode at is operation mode while power is oversupplied from the power system. In this case, the electricity storage apparatus 105 may switch to, for example, an operation mode of increasing the current charging rate (or charging consumption power). In addition, it will be assumed that the electricity storage apparatus 105 is in a non-charging mode as its operation mode while power is oversupplied from the power system. In this case, the electricity storage apparatus 105 may switch to an operation mode of starting the charging. Although the electricity storage apparatus, as described above, may switch its operation mode in order to adjust the amount of available supply power for the demand-side supply resources to correspond to the required amount of power, which is acquired from the inquiry request signal, the electricity storage apparatus 105 may switch to a specific operation mode based on input criteria, or to an input specific operation mode, by receiving from the user the criteria for determining to switch the operation mode or the specific operation mode.

In operation 5, the electricity storage apparatus 105 calculates the amount of power for the demand-side supply resources it can supply to the utilizing side 100, using the charging rate and the amount of available supply power, which is determined in accordance with the operation mode determined in operation 4. The amount of available supply power for the demand-side supply resources refers to the available supply power acquired in accordance with the operation mode determined in operation 4, or the power which is additionally consumed. For example, it will be assumed that while power system lacks power, the electricity storage apparatus 105 is in a charging mode as its operation mode, its charge state corresponds to 80%, and its charging consumption power is 10 kWh. In this case, if the electricity storage apparatus 105 switches to an operation mode of stopping the charging and supplying power of 5 kWh, the amount of available supply power is calculated as 10+5=15 kWh. It will be assumed that the electricity storage apparatus 105 is set to adjust the amount of available supply power, if the constraints set by the user correspond to a range of 20% of the amount of available supply power. Then, the charging consumption power may be calculated as 10 kWh*(1−0.2)=8 kWh, and the amount of available supply power may be calculated as 10−8=2 kWh. The reason for applying the constraints set by the user is because the electricity storage apparatus, like the electricity storage apparatus included, for example, in the electric car, needs to be charged to some extent in advance after a lapse of a predetermined time, if it is not known when the electricity storage apparatus will be used. In other words, this is because the electricity storage apparatus may fail to meet the user's needs if the user desires to use the electricity storage apparatus in the state where the electricity storage apparatus is not properly charged to meet the requirements of the power system or has supplied all the charged power.

In operation 6, the electricity storage apparatus 105 generates information related to the amount of available supply power for the demand-side supply resources.

In step 120, the electricity storage apparatus 105 transmits the information related to the amount of available supply power for the demand-side supply resources to the utilizing side 100. The information related to the amount of available supply power for the demand-side supply resources is detailed information about the amount of available supply power for the demand-side supply resources, which is calculated in operation 5, and includes parameters such as ‘start time’, ‘end time’ and ‘supply power’.

Thereafter, the electricity storage apparatus 105 may receive a result signal for the information related to the amount of available supply power for the demand-side supply resources, from the utilizing side 100. The result signal includes a signal indicating the acceptance or rejection for the provision of the available supply power for the demand-side supply resources.

If the result signal includes a signal indicating “acceptance” of the power usage, the electricity storage apparatus 105 reduces or increases the power usage to correspond to the switching of the operation mode determined in operation 4. On the other hand, if the result signal includes a signal indicating “rejection”, the electricity storage apparatus 105 returns to operation 1 (i.e., an operation before it received the inquiry request signal) without switching its operation mode.

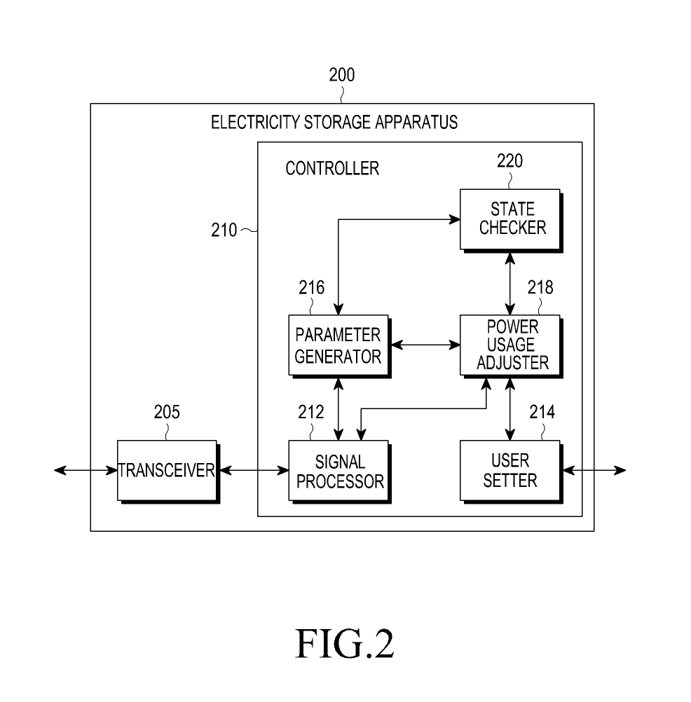

FIG. 2 illustrates a structure of an electricity storage apparatus according to an exemplary embodiment of the present invention.

Referring to FIG. 2, an electricity storage apparatus 200 roughly includes a transceiver 205 and a controller 210. The controller 210 includes a signal processor 212, a user setter 214, a parameter generator 216, a power usage adjuster 218, and a state checker 220.

The transceiver 205 receives an inquiry request signal transmitted from a utilizing side, and forwards the inquiry request signal to the signal processor 212.

The signal processor 212 acquires parameters for utilization-related information of the demand-side supply resources, which will be utilized by the utilizing side, from the inquiry request signal, and delivers the parameters to the power usage adjuster 218.

The power usage adjuster 218 determines the amount of available supply power for the demand-side supply resources based on the parameters acquired from the utilization-related information, determines a switching method for the operation mode depending on the determined amount of available supply power for the demand-side supply resources, and delivers a result of the determination to the state checker 220.

Based on the determined amount of power, the state checker 220 checks the operation mode (for example, the charge state) of the electricity storage apparatus 200, and inquires the charging rate (or charging consumption power) set by the user.

The power usage adjuster 218 determines the amount of available supply power for the demand-side supply resources based on the estimate of the power usage before/after the switching of the operation mode, and delivers a result of the determination to the parameter generator 216.

Based on the determined amount of power, the parameter generator 216 generates information related to the demand-side supply resources, which is to be provided to the utilizing side. In other words, the parameter generator 216 generates parameters corresponding to ‘start time’, ‘end time’, and ‘supply power’ as in operation 6. The supply power may be represented as ‘demand level’, ‘incentive’ or the like. The parameter generator 216 delivers the generated parameters to the transceiver 205 via the signal processor 212.

The transceiver 205 transmits the information related to the amount of available supply power for the demand-side supply resources, which includes the parameters, to the utilizing side 100.

The user setter 214 may receive, from the user, the criteria for determining the switching method for the operation mode of the electricity storage apparatus 200, or a switching command to a specific operation mode. In this case, the power usage adjuster 218 determines a switching method for the operation mode depending on the received criteria or switching command.

As is apparent from the foregoing description, as the electricity storage apparatus uses a power demand adjustment signal, the present invention may utilize the electricity storage apparatus, which is one of the distributed demand-side power supply resources, without the development plan to collect detailed information about a variety of demand-side power supply resources or to increase the number of demand-side power supply resources which are almost impossible to collect in reality. In addition, aspects of the present invention may provide the technical foundation in which the infrastructure of the power system may be utilized practically and effectively, when the environment, in which elements of the power system may exchange information over the wire/wireless communication network, is provided as a smart grid is built, and when many demand-side power supply resources are secured, which will be spread by the continuous technology development and policy support, though they are not currently activated like the demand response apparatus.

While aspects of the invention have been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling power consumption by an electricity storage apparatus, the method comprising:
receiving, from a utilizing side, an inquiry request signal for inquiring whether power supply from the electricity storage apparatus is possible;
inquiring an amount of charged power in the electricity storage apparatus compared to a capacity of the electricity storage apparatus;
comparing a required amount of power, which is included in the inquiry request signal, with the amount of charged power in the electricity storage apparatus, and based on the comparison result, determining an amount of power to supply to the utilizing side and whether to switch to an operation mode of supplying the amount of power to the utilizing side; and
upon determining to switch to the operation mode, checking an amount of available supply power in accordance with the operation mode, and transmitting information about the checked amount of available supply power to the utilizing side.

2. The method of claim 1, wherein the inquiry request signal includes information about at least one of ‘start time’ and ‘end time’ for the power that the utilizing side desires to receive from the electricity storage apparatus, and of ‘incentive’ and ‘demand level’; and
wherein the incentive represents a cost that the utilizing side pays per unit power, and the demand level indicates a risk in adjusting the amount of power supplied by the electricity storage apparatus depending on the required amount of power of the utilizing side.

3. The method of claim 1, wherein the operation mode comprises one of an operation mode of reducing a charging rate or charging consumption power of the electricity storage apparatus, an operation mode of stopping a charging operation, and an operation mode of stopping the charging operation and supplying stored power to the utilizing side, if the electricity storage apparatus is in a charging mode while power is insufficient compared to the capacity of the electricity storage apparatus.

4. The method of claim 1, wherein the operation mode comprises an operation mode of supplying the stored power to the utilizing side, if the electricity storage apparatus is in a non-charging mode while power is oversupplied compared to the capacity of the electricity storage apparatus.

5. The method of claim 1, wherein the d operation mode comprises an operation mode of increasing a charging rate or charging consumption power of the electricity storage apparatus, if the electricity storage apparatus is in a charging mode while power is oversupplied compared to the capacity of the electricity storage apparatus.

6. The method of claim 1, wherein the information about the amount of available supply power includes at least one of ‘start time’, ‘end time’ and ‘supply power’; and
wherein the ‘supply power’ is expressed by converting a power value varying in each time interval into one value.

7. An electricity storage apparatus for controlling power consumption, the apparatus comprising:
a transceiver for receiving, from a utilizing side, an inquiry request signal for inquiring whether power supply from the electricity storage apparatus is possible; and
a controller for inquiring an amount of charged power in the electricity storage apparatus compared to a capacity of the electricity storage apparatus, comparing a required amount of power, which is included in the inquiry request signal, with the amount of charged power in the electricity storage apparatus, determining, based on the comparison result, an amount of power to supply to the utilizing side and whether to switch to an operation mode of supplying the amount of power to the utilizing side, and upon determining to switch to the operation mode, checking an amount of available supply power in accordance with the operation mode, and controlling the transceiver to transmit information about the checked amount of available supply power to the utilizing side.

8. The apparatus of claim 7, wherein the inquiry request signal includes information about at least one of ‘start time’ and ‘end time’ for the power that the utilizing side desires to receive from the electricity storage apparatus, and of ‘incentive’ and ‘demand level’; and
wherein the incentive represents a cost that the utilizing side pays per unit power, and the demand level indicates a risk in adjusting the amount of power supplied by the electricity storage apparatus depending on the required amount of power of the utilizing side.

9. The apparatus of claim 7, wherein the operation mode comprises one of an operation mode of reducing a charging rate or charging consumption power of the electricity storage apparatus, an operation mode of stopping a charging operation, and an operation mode of stopping the charging operation and supplying stored power to the utilizing side, if the electricity storage apparatus is in a charging mode while power is insufficient compared to the capacity of the electricity storage apparatus.

10. The apparatus of claim 7, wherein the operation mode comprises an operation mode of supplying the stored power to the utilizing side, if the electricity storage apparatus is in a non-charging mode while power is oversupplied compared to the capacity of the electricity storage apparatus.

11. The apparatus of claim 7, wherein the controller determines to switch to an operation mode of increasing a charging rate or charging consumption power of the electricity storage apparatus, if the electricity storage apparatus is in a charging mode while power is oversupplied compared to the capacity of the electricity storage apparatus.

12. The apparatus of claim 7, wherein the information about the amount of available supply power includes at least one of ‘start time’, ‘end time’ and ‘supply power’; and
wherein the ‘supply power’ is expressed by converting a power value varying in each time interval into one value.
